(19) United States
(12) Patent Application Publication
(10) Pub. No.: US 2021/0206487 A1
(43) Pub. Date: Jul. 8, 2021

(54) Aircraft and Modular Propulsion Unit

(71) Applicant: Electric Aviation Group LTD, Bristol (GB)

(72) Inventors: Kamran Iqbal, Bristol (GB); Norman Wood, Bristol (GB)

(21) Appl. No.: 17/205,904

(22) Filed: Mar. 18, 2021

Related U.S. Application Data
(63) Continuation-in-part of application No. PCT/GB2019/052623, filed on Sep. 18, 2019.

(30) Foreign Application Priority Data
Sep. 18, 2018 (GB) 1815213.2

(51) Int. Cl. B64C 29/00; B64C 11/28

(52) U.S. Cl. CPC B64C 29/0033; B64D 2027/026; B64C 11/28

(57) ABSTRACT

An aircraft comprising a wing; a tractor propulsion means (TPM); a pusher propulsion means (PPM); a cruising propulsion means (CPM); and wherein the TPM is capable of providing a thrust, the direction of thrust reversibly movable from a forward propelling direction, to an upward propelling direction; and wherein the PPM is capable of providing a thrust, the direction of thrust reversibly movable from a forward propelling direction, to an upward propelling direction; and wherein the CPM is capable of providing a thrust, the direction of thrust being in a forward propelling direction; and wherein the TPM and PPM are connected to the wing, and wherein the TPM is located in fore of the wing and the PPM is located in aft of the wing.

### FIELD OF THE INVENTION

This invention relates to aircraft. In particular, though not exclusively, the invention relates to a VTOL-STOL capable aircraft, as well as modular propulsion part for use with the same.

### BACKGROUND OF THE INVENTION

Aircraft capable of vertical take-off and landing (VTOL) and short take-off and landing (STOL) are known in the art, such as the Bell Boeing V-22 Osprey. However, such aircraft have a number of drawbacks. They are not efficient fliers, often costly to run and maintain, and are not very well suited/tolerated for flying within urban areas.

There remains a need in the art for improved aircraft, in particular aircraft adapted for flight within urban areas.

### SUMMARY OF THE INVENTION

In a first aspect of the invention, there is provided
an aircraft comprising
   a wing;
   a tractor propulsion means (TPM);
   a pusher propulsion means (PPM);
   a cruising propulsion means (CPM); and
   wherein the TPM is capable of providing a thrust, the direction of thrust reversibly movable from a forward propelling direction, to an upward propelling direction; and
   wherein the PPM is capable of providing a thrust, the direction of thrust reversibly movable from a forward propelling direction, to an upward propelling direction; and
   wherein the CPM is capable of providing a thrust, the direction of thrust being in a forward propelling direction; and
   wherein the TPM and PPM are connected to the wing, and wherein the TPM is located in fore of the wing and the PPM is located in aft of the wing.

The aircraft of the invention has in effect three means of propulsion. It has a tractor propulsion means (TPM), located in fore of the wing, i.e. for ‘pulling’ the aircraft forward. It has a pusher propulsion means, located in aft of the wing, i.e. for ‘pushing’ the aircraft forward. These can act in concert to propel the aircraft in a forward direction with a forward acting force. The thrust generated by the TPM and PPM can be reversibly moved (i.e. moved and moved back again) such that the thrust can be directed in an upward direction. Therefore, these can act in concert to propel the aircraft in an upward (skyward) direction with an upward acting force. The upward acting force offsetting the pull of gravity. Therefore, the TPM and PPM can have a dual function, to either lift the aircraft up or to propel the aircraft forward. However, propulsion means suitable for generating the necessary force to vertically lift an aircraft up are not very efficient for cruising flight. For example the Bell Boeing V-22 Osprey (hereafter ‘Osprey’) aircraft requires very large propeller blades to generate the necessary lifting force for vertical lift off. In horizontal flight the large resultant weight and drag of the large propeller blades reduce the range and efficiency of the vehicle in horizontal (cruising) flight. The Osprey is also noisy. The present invention has the capability to use the TPM and PPM for lift off, but to switch to cruising propulsion means (CPM) for cruising (horizontal) flight. In horizontal flight the energy requirements are considerably lower (than in lift off flight) and so a smaller more energy efficient propulsion means can be used. Such propulsion therefore requires less fuel/energy and so the aircraft has the capability to fly further. In addition, the CPM has the capacity to be considerably quieter in operation than typical VTOL-type propulsion units, due to its smaller size. Noise pollution in urban environments is a serious matter, and so low noise, energy efficient flight is of great benefit.

Also of benefit to the invention is having a propulsion means connected in fore (puller) and aft (pusher) of the wing. This means smaller more efficient propulsion units can be employed than having larger propulsion means located in just fore (as is typical), or just aft of the wing. For example, the Osprey has two large single propellers in fore of the wing.

Allowing the TPM and PPM to produce thrust movable from a forward propelling direction, to an upward propelling direction offers flexibility in flight modes, and can offer an additional level of safety in the situation of a malfunction.

It should be noted that a tractor type propulsion means produces an upward thrust when orientated appropriately and run in a conventional manner. For example, if a tractor propeller is pointed upwards and run normally, this will produce an upward thrust, i.e. an upward propelling direction. However, if the tractor propeller was enabled with a variable pitch, it could be pointed downward, and with the correct variable pitch enabled, this would also produce an upward thrust. Likewise, if a pusher propeller is pointed downwards and run normally, this will produce an upward thrust. However, if a pusher propeller was enabled with a variable pitch, it could be pointed upwards, and with the correct variable pitch enabled, this would also produce an upward thrust.

Therefore, there are several ways for the invention to produce a lifting thrust. For example, in the situation where the TPM and PPM are tractor and pusher propellers respectively, then an upward thrust is produced where the tractors are pointed upward and the pushers pointed downward (e.g. see FIG. 1). If the tractor and pusher propellers had a variable pitch capacity, then an upward thrust could be generated when these were run with a suitable variable pitch, but in this case where the tractor is pointed down and the pusher pointed up. Therefore, in this example, with proper attention to the correct pitch of the propellers, the aircraft could be flown with all propellers up, all propellers down or up-down and down-up configurations. This therefore allows for increased failsafe in case of an equipment failure. Possibly, if there were an obstacle on the ground, or in the case of an evacuation pick-up, or for cargo pick-up, it might be beneficial to have all the propellers pointing upward. Similarly, it might be beneficial to run the aircraft with all propellers down, e.g. to avoid powerlines, branches or birds, or for better visibility.

In addition, it is considered that a net downward thrust (or reduced net upward thrust) could be produced by the correct orientation/running of the TPM and PPM.

There is another benefit of connecting both the TPM and PPM to the wing. The necessary infrastructure needed to allow the aircraft to communicate (in terms of energy, information and control) with the propulsion means is greatly simplified. That is, because the TPM and PPM is located/concentrated in the wing area, this greatly simplifies the design, manufacture and assembly of the aircraft as a whole. The fuel/energy lines, electrical cables, control means and sensors can be directed/ducted simply from the cockpit area to the wing area. This would for example allow the wing inclusive of the propulsion means to be manufactured as a single (e.g. monolithic) unit, and later combined with the rest of the aircraft. Modular construction of this kind leads to great savings in cost and time. Also repair and maintenance is simplified.

In some prior art VTOL-type aircraft, the propulsion means are of all of the same kind (e.g. limited to a plethora of tractor propellers in front of the wings). This means to generate enough lifting force the propellers need to be (i) very large; or (ii) the leading wing surface needs to be large to accommodate many smaller propulsion units, or (iii) the tractors need to be distributed all about the aircraft, e.g. on the wing, as well as on the passenger compartment and/or on the tail (the tail may require wing-like appendages to host the tractors). In the case of (i) as mentioned above, this leads to inefficient flight and is noisy. In the case of (ii) this leads to unnecessarily cumbersome aircraft, more costly to manufacture, expensive to store in urban areas, and is also inefficient in flight. In the case of (iii) the infrastructure required within the aircraft to communicate energy/fuel, information and control means, becomes widely distributed. This therefore increases the costs and the aircraft requires complex assembly. The cost of maintenance and fault checking likewise increases exponentially. There is also an increased chance of parts failure. Therefore, having a communication network that fans out through out the various parts of the aircraft means that modular assembly of the aircraft is greatly limited, preventing access to this saving in manufacturing costs (unlike the invention).

In an embodiment, the aircraft comprises a payload compartment, the compartment located equidistant between the tips of the wing, or is located between two wings. The payload compartment is designed to carry a payload. The payload could be civilian, scientific, commercial and/or military. The payload compartment may be a passenger compartment, it could be a cargo carrying compartment (e.g. for goods, mail, ordnance etc.), and/or the payload could be hardware (e.g. a large camera, weapon, or other machine). In the case of a passenger compartment, this could be forward or backward facing. The direction of flight defining the ‘forward’ (horizontal) direction, as opposed to the direction the passengers are facing per se. In the case where the payload compartment comprises hardware like a machine, this may be temporally or permanently fixed in place. The aircraft could be piloted directly by a person (single pilot operation), and/or remotely, and/or it could be autonomous. The aircraft could be configured to fly with a range of centre of gravity (CG) positions. The payload compartment e.g. the passenger compartment could be any reasonable shape.

In an embodiment, the aircraft comprises two wings, each wing comprising a TPM and PPM. The aircraft could comprise a single (mono) wing, or the aircraft could comprise a plethora of wings. For simplicity of design it is convenient to manufacture a single (monolithic) wing, or an aircraft with two wings. The fewer the parts, the simpler the assembly of the aircraft, and hence the cheaper it is to make.

In an embodiment, the wing is an aerofoil, or has a lifting surface. Optionally the wing is capable of providing the aircraft with glided flight. For efficient cruising flight, the wing beneficially has an aerofoil shape and sufficient surface area to allow the aircraft to glide. In an embodiment, the wing is a wing-like body, the body substantially incapable of glided flight. For example, the wing may be a boom-like structure (or some other structure). This embodiment has some advantages associated with ease of manufacture, and will have a low mass, and with associated efficiencies in cruising flight.

In an embodiment, the TPM, PPM and CPM are independently (i) battery powered; (ii) battery-hybrid powered or (iii) turbo-electrically powered. It is considered that all three power trains are allowed by the invention. For urban flying, in particular intra-city flying, having a battery powered aircraft would beneficially have low emissions and produce no or little noise pollution. An urban area would have many places to recharge batteries, e.g. between meetings. For battery flight, in particular, it is important to ensure the vehicle is highly efficient in flight. A hybrid powered aircraft (e.g. battery and hydrocarbon fuel powered) offers the battery linked benefits of low pollution and low noise running within an urban environment, but with a backup source of energy in case of need, or emergency. In addition, any excess energy produced in non-battery powered flight, could be used to charge the batteries, in particular when flying between urban areas, where noise and emissions are better tolerated. Turbo-electrically powered aircraft have better powertrain efficiency, hence better fuel efficiency compared with conventionally powered gas turbine driven aircraft. The turbo-electric engine enables a distributed propulsion system, where one gas turbine and generator is producing electric power to run several small propulsive motors. The distributed propulsion allows significantly greater propulsive efficiency than prior art high bypass turbofan engines. The turbo-electric system enables the distributed propulsion system implementation, and as such is also a beneficial powertrain in the aircraft of the invention.

In an embodiment, the TPM and PPM each independently comprise one or more propulsion units; optionally the propulsion units comprise electric motors. The TPM and PPM are units capable of producing thrust in controlled but variable directions. The TPM and PPM may each comprise one propulsion unit, or many.

In an embodiment, the TPM and PPM independently comprise 1 to 24 propulsion units, further optionally the TPM and PPM propulsion units are the same in number. In an embodiment, the TPM and PPM each independently comprise 3, 4, 5, 6, 7 or 8 propulsion units. In an embodiment, the TPM and PPM independently comprise 6 to 24 propulsion units.

FIG. 1 illustrates a configuration with 6 TPM and 6 PPM propulsion units. An advantage of a configuration with 6 or more units is that the rotation from vertical to horizontal force and vice versa, can be sequenced in time so that only units at specific symmetric span locations are moving at any one time. This may be beneficial during transition from hover to forward flight and returning to hover, in that the loss of vertical thrust could be gradually compensated for by the increasing lift contribution from the fixed wing or the remaining propulsion units. This may result in a smoother transition with less likelihood of loss of altitude and/or control. The phased transition sequence could initiate from any of the spanwise symmetric pairs of propulsion units i.e. from outboard to inboard, vice versa or any other sequence that is symmetric. It is possible that the phased rotation sequences could overlap or be separated. The phased sequence could also embody variations of thrust on any individual propulsion unit pair to further improve the transition manoeuvres, from hover to forward flight and the return. Phased sequencing during transition could also be applied to configurations with less than 6 TPM and 6 PPM units but more than 2 of each.

Having many smaller propulsion units has several additional advantages. These can be cheaper to manufacture, transport and/or replace than larger units. This is especially true of highly efficient electrical motors. In the case where one unit fails, there are many more to compensate for this failure. Also, for example, in propeller driven aircraft, each blade of a propeller needs to be made bigger than is necessary (as a failsafe), so that it can cope should one of the other propellers fail. When there are many smaller propellers, this redundancy can be split over all the propellers, and this results in a large saving in total weight and blade surface area. The invention therefore can work if one or more of the propulsion units should fail. The overall reduction in the blade surface area (as well as a corresponding reduction in motor size and weight) produces a reduction in drag, and so there is an overall gain in the flight efficiency, especially in cruising flight. Another benefit of having multiple propulsion units is that the increase in flow/speed of air over the wing can generate extra lift (i.e. Distributed Electric Propulsion), and so in the case of STOL, shorter runways are needed for take-off. That is, Distributed Electric Propulsion allows more lift with less wing area. More lift with less wing area enables STOL performance, and less drag throughout the flight, hence overall better efficiency and performance in cruise flight. Smaller aircraft are better suited to urban areas.

In an embodiment, the propulsion units comprise a propeller or ducted fan. It is considered that any means of producing the desired thrust according to the invention could be beneficially employed in the invention.

In an embodiment, the propulsion unit or units are arranged to be reversibly tiltable in an upward and/or downward direction, thereby enabling a change in the direction of thrust. For example, where the propulsion units are propellers, in a first position, the propellers could be arranged to produce a forward propelling thrust. In a second position, the propellers could be arranged to point upward (skyward) or downward (groundward) to produce an upward propelling thrust. Movement from the first to second position could for example be achieved by movement upon a pivot or hinge. Movement could be achieved by means known to the skilled person, e.g. actuators, hydraulic means, electrical motors, etc. An appropriate locking means, or ratchet, may secure the position of the propulsion unit in the start or finish position, or any position therebetween. Likewise, in the case of a ducted fan, pivoting may allow movement between two positions. It is considered, in an embodiment, that to effect the movement of the TPM/PPM, the wing (or part of the wing) could also be moved. It is considered that in the case where the TPM/PPM is located on a boom, the boom (or part of the boom) could be moved to effect the necessary movement of the TPM/PPM.

In an embodiment, the propulsion units of the TPM and PPM are arrangeable to cooperate for lifting, hovering, low speed flying, or controlled descent of the aircraft. In an embodiment, in lift off mode, the TPM is arranged in an upward propelling direction, and the PPM is arranged in an upward propelling direction. In an embodiment, in low speed, hover, near hover flight mode, or controlled descent mode, the TPM is arrange in an upward propelling direction, and the PPM is arranged in an upward propelling direction; wherein the net thrust results in maintaining a steady altitude, or in a controlled descent (e.g. with the assistance of gravity). During VTOL flight/lift-off, the various propulsion units of the TPM and PPM can be configured as needed to produce the correct level of thrust. In hover-type flight, the force of gravity pulling the aircraft downward is substantially off-set by the upward thrust of the TPM and PPM. As explained above, this might even be achieved by using propellers with variable pitch. When the TPM and PPM consist of a large group of propulsion units, e.g. propellers, optimum lift and control can be achieved by the arrangement of the propulsion units fore and aft of the wing, inclusive of direction of rotation (see FIG. 3, which shows an example arrangement of tractor and pusher propellers inclusive of the direction of rotation of each propeller). In the case of propulsion units which are propellers, due care is needed to ensure that at least the blades of the propellers do not collide, e.g. by separation.

In an embodiment, when the TPM and/or PPM are not in use, they are capable of being arranged, or stored/stop-fold, in a low-drag/aerodynamic arrangement. The TPM and PPM are ideally suited to lifting the aircraft (and landing again), or even for STOL. However, they consequentially do not give very efficient cruising flight. Accordingly, in this embodiment, when the TPM and/or PPM are not required, they can be put into an aerodynamic configuration, or stored/stop-fold in an aerodynamic housing, or perhaps retracted within the wing space. This means the drag resulting from the TPM and/or PPM can be lowered or eliminated. This has a consequential increase in cruising efficiency. In an embodiment, when the TPM and/or PPM comprise a propeller, the propeller blades can be foldable; optionally wherein the propeller blades fold in a direction towards the wing, or in a direction away from the wing. In some embodiments the propeller blades may be configured to fold into a low-drag arrangement by folding to point in an aftward direction, parallel with airflow resulting from forward movement of the aircraft (i.e. with the root of each propeller blade upstream of the tip of each propeller blade). The blade and body geometry of the propeller can be adapted to minimise flow separations when the blades are in the folded/stowed position. It is conceived that the drag resulting from propellers can be reduced by simply folding the blades. Again, this means the aircraft would be more efficient at cruising flight. In particular, such an efficiency saving would greatly increase the in-flight time (hence range) of any aircraft, especially important when the aircraft is powered by battery i.e. increasing battery endurance and aircraft range.

In an embodiment, the TPM and/or PPM are connected to one or more booms, the one or more booms being connected to the wing, wherein the booms extend fore and aft of the wing. In an embodiment, the one or more propulsion units of the TPM are located with the fore portion of the booms and the one or more propulsion units of the PPM are located with the aft portion of the booms; optionally the propulsion units are located at the distal end of the booms. It is considered that a boom could conveniently allow the TPM and PPM to be located fore and aft of the wing respectively. For example, a boom extending under the wing could allow for one or more propulsion units to be located in front of the leading edge of the wing. Also, for example, this boom (or another boom) extending under the wing could allow for one or more propulsion units to be located in behind of the trailing edge of the wing. In an embodiment, a boom could have a tractor propulsion means at one end and a pusher propulsion means at the other end. The booms could be above the wing and/or below the wing. The booms could lie substantially in the plane of the surface of the wing. The booms could be withdrawn into the wing space, possibly being telescopic. The booms could be cross-linked or be separate. The booms may be substantially straight or forked. The booms fore and aft could be in series/alignment or may be in a staggered arrangement. It is also considered that with a correct rotational/transmittal means, a single motor unit could power both a tractor and pusher propeller (e.g. a motor located in about the mid portion of the boom could power a tractor and pusher propeller located at each end of the boom). In an embodiment, the TPM/PPM and/or booms are attached to wing ribs or wing spars, i.e. front spar and rear spars.

In an embodiment, the weight of the TPM and PPM is distributed to provide little or no turning moment on the aircraft, e.g. equal distance from aircraft centre of gravity.

In an embodiment, the propulsion units of the TPM and/or PPM form no part of the CPM. In an embodiment, the CPM is located on the transport compartment and/or on the wing; optionally the CPM is located on the wing tips or on winglets. It is considered that the CPM is best optimised for cruising flight. Likewise, the TPM and PPM is best optimised for VTOL. In an embodiment, when the TPM/PPM propulsion units are propellers, these are these optimised for vertical take-off and landing. In an embodiment, when the TPM/PPM propulsion units are propellers, these are optimised for hover performance and low noise. The demands of each flight mode can require quite different propulsion units. For example, a far less powerful tractor or pusher propelling means could be used to propel (thrust in a forward propelling direction) an aircraft which is already flying. Using one or more of the propulsion units of the TPM/PPM for cruising flight may give less efficient cruising flight. In the case of at least battery powered aircraft, lowered cruising flight efficiency could greatly reduce the airtime duration, hence range of the aircraft. In a beneficially efficient arrangement, inter- and intra-city flight is permitted by the invention.

In an embodiment, the CPM is located in fore and/or aft of the transport compartment. In an embodiment, the CPM is located on the nose of the aircraft and/or tail of the aircraft, and wherein the aircraft comprises a nose and/or tail. In an embodiment, the CPM comprises one or more propulsion units. In an embodiment, the propulsion units comprise propellers or ducted fans. There are many places the CPM could be located on the aircraft and in different configurations. The exact location may be determined to provide the most efficient cruising flight (e.g. winglets), or where there is space (e.g. each side of the passenger compartment). In an embodiment, the CPM comprises a tractor and/or pusher propulsion means. As mentioned above the CPM may be (i) battery powered; (ii) battery-hybrid powered or (iii) turbo-electrically powered. This power source might be separate to the TPM/PPM power source. When the CPM comprises two or more propulsion units, this may be used in steering/controlling the aircraft by generating variable thrust, i.e. generating roll, pitch and yaw.

In an embodiment the propulsion units of the CPM comprise propellers. In an embodiment the propellers comprise 2 blades. That said, the size, number (1, 2, 3, 4, 5, 6, 7, 8, 9 or 10) and configuration of the blades of the propellers can be altered, more specifically to provide efficient cruising flight to the aircraft.

In an embodiment the CPM is adapted and/or optimised for efficient cruising flight of the aircraft.

In an embodiment, the CPM has propulsion units which are reversibly tiltable from a forward propelling direction to an upward and/or downward propelling direction.

In an embodiment the propulsion units of the TPM, PPM and/or CPM are arrangeable to effect steering/control of the aircraft, by means of varying the relative thrusts of the corresponding propulsion units. This may be a simple and convenient way to steer/control the aircraft by generating unequal thrusts, thereby generating roll, pitch and yaw. Another way would be to induce extra drag on one side of the aircraft, e.g. on the wing, perhaps with flaps/spoilers, and/or by partially or fully opening a TPM/PPM propeller, creating drag.

In an embodiment the aircraft comprises one or more control surfaces. The control surfaces such as ailerons (rolling moment), Elevators (pitching moment) and Rudder (yawing moment) can be used to control the aircraft. The booms (or part of the booms) may also be used as control surfaces to control the aircraft, perhaps by movement to effect controlled variable drag (e.g. the variable tilting of the booms in the direction lateral to the direction of travel). In some embodiments, control over the aircraft may be achieved by pitching (rotation around aircraft lateral axis i.e. y-axis) or rotating (rotation around aircraft vertical i.e. z axis and/or longitudinal axis i.e. x-axis) booms variably on both wings without changing thrust or by pitching (rotation around aircraft lateral axis) or rotating (rotation around aircraft vertical and/or longitudinal axes) booms variably on both wings in addition to varying the relative thrust of the corresponding propulsion units or by pitching (rotation around aircraft lateral axis) or rotating (rotation around aircraft vertical and/or longitudinal axes) booms invariably and symmetrically on both wings in addition to varying the relative thrust of the corresponding propulsion units, thereby generating roll, pitch and yaw.

In an embodiment the vehicle is capable of both vertical take-off and landing (VTOL) and short take-off and landing (STOL).

A number of standard safety measures would of course be implemented in the aircraft of the invention and the embodiments thereof. In an embodiment, a ballistic parachute could ensure safe recovery of the aircraft and any persons unable to escape in the case of an inflight emergency.

In a second aspect of the invention, there is provided an aircraft comprising
a wing;
a tractor propulsion means (TPM);
a pusher propulsion means (PPM);
a cruising propulsion means (CPM); and
wherein the TPM is capable of providing a thrust:
   i) the direction of thrust reversibly movable from a forward propelling direction, to an upward propelling direction; or
   ii)) the direction of thrust fixed in an upward propelling direction;
wherein the PPM is capable of providing a thrust:
   i) the direction of thrust reversibly movable from a forward propelling direction, to an upward propelling direction; or
   ii)) the direction of thrust fixed in an upward propelling direction;
wherein the CPM is capable of providing a thrust, the direction of thrust being in a forward propelling direction; and
wherein the TPM and PPM are connected to the wing, and wherein the TPM is located in fore of the wing and the PPM is located in aft of the wing.

At least one of the CPM and TPM may be capable of providing a thrust with a direction of thrust reversibly movable from a forward propelling direction, to an upward propelling direction.

The optional features described with reference to the first aspect are equally applicable to the second aspect.

In a third aspect of the invention, there is provided
an aerial propulsion module comprising
   a separating body;
   a tractor propulsion means (TPM);
   a pusher propulsion means (PPM);
wherein the TPM and PPM independently comprise one or more propulsion units, the propulsion units comprising an electric motor; and
wherein the TPM and PPM are connected to and spaced apart by the separating body; and
wherein the separating body is fixable to the wing of an aircraft; and
wherein, when the separating body is attached to a wing of the aircraft, the TPM is arranged to lie in fore of the wing and the PPM is arranged to lie in aft of the wing; and
wherein, when the separating body is attached to a wing of the aircraft, the TPM is capable of providing a thrust, the direction of thrust reversibly movable from a forward propelling direction, to an upward propelling direction; and wherein, when the separating body is attached to the wing of an aircraft, the PPM is capable of providing a thrust, the direction of thrust reversibly movable from a forward propelling direction, to an upward propelling direction;
and wherein the TPM and PPM have means capable of communication with the aircraft.

This aspect of the invention considers a modular propulsion unit that for example may be assembled and attached to a range of aircraft configurations. Such a module would be efficient to manufacture, having the TPM and CPM located as part of the module, and the aircraft and modules could for example be manufactured by different parties. The module could be fixed to an aircraft by for example standardised fixing points or could be welded in place. The module could have the capacity to communicate with the aircraft. The means of communication, i.e. power/fuel/information communication lines, could be preinstalled in the module, or be installed when being fixed to an air craft. Electric motors are very efficient and would provide a very efficient propulsion unit in the module. The module could be (i) battery powered; (ii) battery-hybrid powered or (iii) turbo-electrically powered.

In an embodiment, the separating body is a boom, or an aerodynamic elongate shape, optionally the TPM and PPM are located at the distal ends of the structure/boom. The size of the boom could be manufactured to suit the aircraft that is destined to house the module. For example, a wing that is quite wide would require a longer boom. The structure/boom may be telescopic.

In an embodiment, the TPM and PPM each comprise a single propulsion unit. In this simple configuration, a pusher and puller propulsion means could be separated by a single boom, and hence represent a simple and cost effective way of making the module.

In an embodiment, the propulsion units comprise a propeller or ducted fan. Other suitable propulsion units are considered.

In an embodiment, when the separating body is attached to a wing of an aircraft, the propulsion units are arranged to be reversibly tiltable in an upward and/or downward direction, thereby enabling a change in the direction of thrust. In an embodiment, the propulsion units are arranged to reversibly tilt in opposite directions. These embodiments have substantially similar (or identical) benefits to the corresponding parts mentioned above when considering the first (or second) aspect of the invention.

In a fourth aspect, there is provided
an aircraft comprising one or more aerial propulsion modules of the second aspect of the invention.

An aircraft of this aspect can benefit from the reduced associated manufacturing cost of the module. More or fewer modules may be reversibly (or permanently) attached to the aircraft, for example based on the expected payload to be carried by the aircraft. Repair, maintenance and fault isolation is also simplified, saving on the running costs of such an aircraft. In an embodiment, the aircraft has an independent means of propulsion (i.e. not linked to the module).

In a fifth aspect of the invention, there is provided an aircraft or module according to any one of the first, second, third or fourth aspects of the invention, for use in aviation.

In a sixth aspect of the invention, there is provided a method of transitioning to VOTL flight wherein

the direction of thrust of the TPM which is capable of providing a thrust, is arranged in an upward propelling direction, and/or the direction of thrust of the PPM which is capable of providing a thrust, is arranged in an upward propelling direction, and wherein the propulsion units are turned on when so arranged.

In a seventh aspect of the invention, there is provided a method of transitioning to STOL or cruising flight wherein

the direction of thrust of the TPM which is capable of providing a thrust, is arranged in a forward propelling direction, and/or the direction of thrust of the PPM capable of providing a thrust, is arranged in a forward propelling direction; and wherein the propulsion units are turned on when so arranged; and/or the TPM and PPM are turned off when the direction of thrust of the TPM/PPM capable of providing a thrust is arranged in an upward propelling direction.

In an embodiment, the propulsion units of the TPM/PPM are moved or stored/stop-fold, in a low-drag/aerodynamic arrangement after turning off the TPM/PPM.

In an embodiment, where the propulsion units comprise a propeller with foldable blades, the propellers are folded after turning off the propulsion units. In an embodiment, the propeller blades are folded in a direction towards the wing.

It is considered that in an example where the aircraft of the invention has propulsion units which are propellers with foldable blades, the following is an example of the steps which could be taken during VTOL take-off, cruising flight and VTOL landing. The tractor propellers are pointed upward (skyward) and the pusher propellers are pointed downward (groundward). If the propellers had been folded (e.g. for safe storage), they would first be opened (unfolded). The propellers would then be tilted then rotated to generate lift. When the desired height (altitude) was reached, the propellers would be turned off, untilted and retracted pointing in a horizontal direction. If not needed for horizontal (forward) propulsion they would then be folded to reduce drag (or placed into a low-drag housing). If needed for forward propulsion these could be turned on again. The CPM could be turned on whenever forward propulsion was desired; but probably when cruising flight was desired. For VTOL landing, the reverse of the above steps could be employed. That is, the propeller blades could be unfolded, moved/tilted from a horizontal position to point upward (tractors) or downward (pushers) and then turned on. The resultant up thrust would not exceed the pull of gravity for this controlled descent mode. As mentioned previously, in the case of propellers with variable pitch, the tractors could be pointed downwards to generate up thrust, and/or the pushers pointed upwards to generate up thrust.

In an eighth aspect, there is provided an aircraft comprising a wing, wherein the leading edge of the wing comprises a TPM capable of providing a thrust, the direction of thrust in an upward propelling direction; and wherein the trailing portion of the wing comprises a PPM capable of providing a thrust, the direction of thrust in an upward propelling direction; wherein the TPM and/or PPM is housed within the wing. In this aspect, the manufacture and installation is simplified. Optionally the wing comprises a reversibly movable cover; and wherein when not in use the TPM and/or PPM is covered by the cover. The TPM and PPM can be protected from accidental damage (bird strike and from foreign object debris etc.) by the cover. When needed, for VTOL-type flight, the TPM/PPM could be uncovered by the movement of one or more covers. The cover or covers may be above the wing, below the wing or both. The cover may reversibly slide over (or within) the wing surface Further optionally, the TPM and/or PPM is moveable out of the wing space in use. In an embodiment of this aspect, the TPM and/or PPM can comprise one or more propulsion units (e.g. propellers or ducted fans), and these units could be installed/embedded in the wing in the lateral direction (along the wing span), or they can be embedded in the wing in the longitudinal (chord-wise position) direction.

In a ninth aspect of the invention, there is provided an aircraft, or module, substantially as herein described with reference to or as illustrated in the accompanying drawings.

The terms “fore” and “aft” are used as per their normal and well-understood definitions in the field of aerospace to denote, respectively, towards the front of the aircraft (towards the normal direction of travel) and towards the rear of the aircraft (away from the normal direction of travel).

The present invention will now be further described with reference to the following non-limiting examples and the accompanying illustrative drawings, of which:

### BRIEF DESCRIPTION OF THE DRAWINGS

FIG. 1 is a back-side perspective view of an embodiment of the invention, where the propeller blades are deployed (unfolded).

FIG. 2 is a front-side perspective view of the same embodiment, where the propeller blades are folded.

FIG. 3 is a schematic top view of an embodiment of the invention, showing the relative spin directions of the propellers (clockwise or counter clockwise).

FIG. 4 shows another embodiment of the invention from a top perspective view.

FIG. 5 shows another embodiment of the invention from a top perspective view.

Like features have been given like reference numerals.

### DETAILED DESCRIPTION OF THE INVENTION

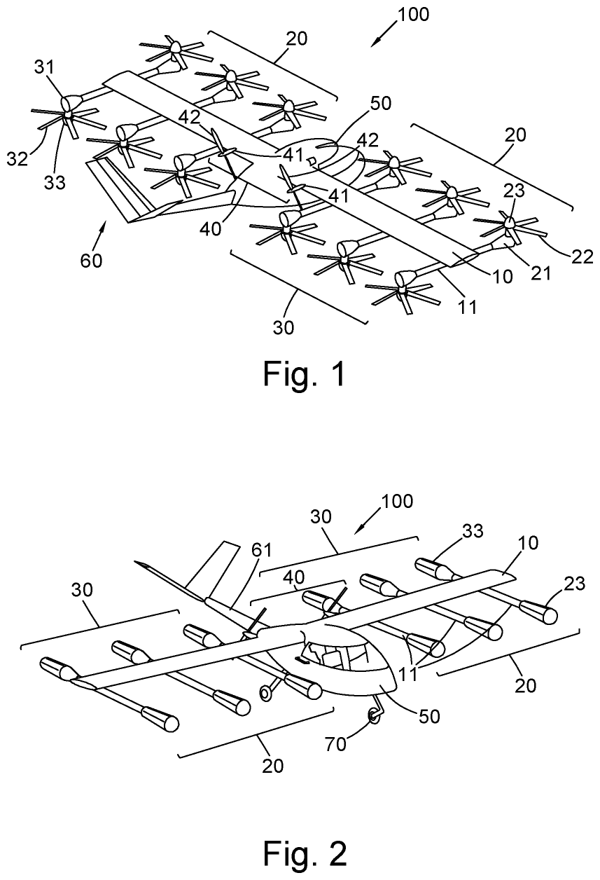

FIG. 1 shows a back-side perspective view of an embodiment (100) of the aircraft of the invention. The aircraft has two wings (10) attached to a cockpit/passenger-carrier (50), and has a tail portion (60). The tail portion has an elongate tail boon (61) with V-shaped tail fins (62). The aircraft has a slender streamlined body aligned with the airflow.

Below each wing are three booms (11), on the end of the booms are mounted propulsion units, i.e. a tractor propeller (21) and a pusher propeller (31), each propeller having 6 foldable blades (22, 32). The blades are in the unfolded (open) configuration. The tractor propellers (21) are pointing upward and the pusher propellers (21) are pointing downward. On the trailing edge of the wings (10), close to the cockpit/passenger-carrier (50), there are two two-bladed pusher propellers (41). The tractor propellers (21) combine to form part of the TPM (20), the pusher propellers (31) combine to form part of the PPM (30), and the two two-bladed propellers (41) combine to form part of the CPM (40). The aircraft has landing gear (70).

FIG. 2 shows substantially the same embodiment as FIG. 1, but from a front-side perspective view. The main change from FIG. 1 to FIG. 2 is that the foldable blades (22; 32) of the propulsion units (21; 31) have been folded into a closed position (23; 33), lowering air resistance of the propellers.

In FIG. 1, the aircraft is shown in a VTOL flight mode and in FIG. 2 the aircraft is shown in a cruising flight mode, being powered only by the two two-bladed (42) propellers (41).

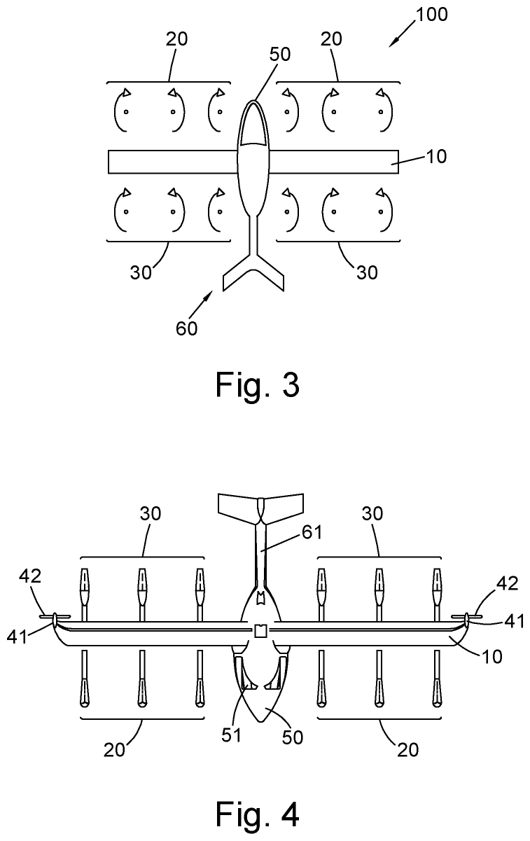

FIG. 3 shows a schematic representation of the aircraft of FIG. 1, the relative directions of rotation of the tractor propellers and pusher propellers during a typical VTOL lift-off are shown. The ‘dot’ in the figure represents the axis of rotation, and the arrows indicate the direction of rotation (as seen from above).

FIG. 4 shows substantially the same embodiment as FIG. 2, but from a top perspective view. The main change from FIG. 2 to FIG. 4 is that the two two-bladed pusher propellers (41) have been relocated on winglets on the wing tips.

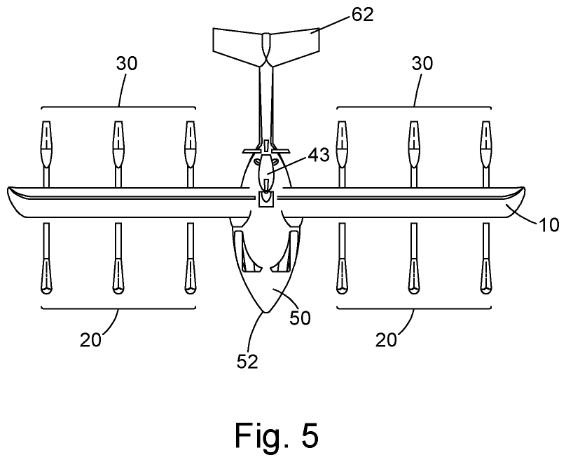

FIG. 5 shows substantially the same embodiment as FIG. 2, but from a top perspective view. The main change from FIG. 2 to FIG. 5 is that the two two-bladed pusher propellers (41) have been replaced with a turbo-electric engine mounted above and between the wings. This can be used for cruising flight and any excess power could be used to charge any batteries present.

1. An aircraft comprising
a wing;
a tractor propulsion means (TPM);
a pusher propulsion means (PPM);
a cruising propulsion means (CPM); and
wherein the TPM is capable of providing a thrust, the direction of thrust reversibly movable from a forward propelling direction, to an upward and propelling direction; and
wherein the PPM is capable of providing a thrust, the direction of thrust reversibly movable from a forward propelling direction, to an upward and propelling direction; and
wherein the CPM is capable of providing a thrust, the direction of thrust being in a forward propelling direction; and
wherein the TPM and PPM are connected to the wing, and wherein the TPM is located in fore of the wing and the PPM is located in aft of the wing.

2. The aircraft of claim 1, wherein the TPM, PPM and CPM are independently (i) battery powered; (ii) battery-hybrid powered or (iii) turbo-electrically powered.

3. The aircraft of claim 1, wherein the TPM and PPM each independently comprise one or more propulsion units and the propulsion units comprise electric motors.

4. The aircraft of claim 3, wherein each TPM and PPM comprises 1 to 24 propulsion units, further optionally the TPM and PPM propulsion units are the same in number.

5. The aircraft of claim 3, wherein the propulsion units comprise a propeller or ducted fan.

6. The aircraft of claim 3, wherein the propulsion units are arranged to be reversibly tiltable in an upward and/or downward direction, thereby enabling a change in the direction of thrust.

7. The aircraft of claim 3, wherein the propulsion units of the TPM and PPM are arrangeable to cooperate for lifting, hovering, low speed flying, or controlled descent of the aircraft.

8. The aircraft of claim 1, wherein, when the TPM and/or PPM comprise a propeller, the propeller blades are foldable; optionally wherein the propeller blades fold in a direction towards the wing.

9. The aircraft of claim 1, wherein the TPM and/or PPM are connected to one or more booms, the one or more booms being connected to the wing, wherein the booms extend fore and aft of the wing, wherein the one or more propulsion units of the TPM are located with the fore portion of the booms and the one or more propulsion units of the PPM are located with the aft portion of the booms; optionally the propulsion units are located at the distal end of the booms.

10. The aircraft of claim 1, wherein the CPM is located on: i) a payload compartment; ii) on the wing; iii) on the wing tips or iv) on winglets.

11. An aircraft of claim 1, wherein the CPM optimised for cruising flight and the TPM and PPM are optimised for VTOL.

12. The aircraft of claim 1, wherein the propulsion units of the CPM, TPM and/or PPM are arrangeable to effect control/steering of the aircraft, by means of varying the relative thrusts of the propulsion units and/or by varying a direction of thrust of each of the propulsion units.

13. The aircraft of claim 1, wherein the aircraft is capable of both vertical take-off and landing (VTOL) and short take-off and landing (STOL).

14. An aerial propulsion module comprising
a separating body;
a tractor propulsion means (TPM);
a pusher propulsion means (PPM);
wherein the TPM and PPM independently comprise one or more propulsion units, the propulsion units comprising an electric motor; and
wherein the TPM and PPM are connected to and spaced apart by the separating body; and
wherein the separating body is fixable to the wing of an aircraft; and
wherein, when the separating body is attached to a wing of the aircraft, the TPM is arranged to lie in fore of the wing and the PPM is arranged to lie in aft of the wing; and
wherein, when the separating body is attached to a wing of the aircraft, the TPM is capable of providing a thrust, the direction of thrust reversibly movable from a forward propelling direction, to an upward propelling direction; and wherein, when the separating body is attached to the wing of an aircraft, the PPM is capable of providing a thrust, the direction of thrust reversibly movable from a forward propelling direction, to an upward propelling direction;
and wherein the TPM and PPM have means capable of communication with the aircraft.

15. The module of claim 14, wherein the separating body is a boom; optionally the TPM and PPM are located at the distal ends of the boom.

16. The module of claim 14, wherein the propulsion units comprise a propeller or ducted fan.

17. The module of claim 14, when the separating body is attached to a wing of an aircraft, and the propulsion units are arranged to be reversibly tiltable in an upward and/or downward direction, thereby enabling a change in the direction of thrust.

18. The module of claims 14, wherein the propulsion units of the TPM and PPM are arranged to reversibly tilt in opposite directions.

19. An aircraft comprising one or more aerial propulsion modules according to claim 13.

20. An aircraft comprising
a wing;
a tractor propulsion means (TPM);
a pusher propulsion means (PPM);
a cruising propulsion means (CPM); and
wherein the TPM is capable of providing a thrust:
i) the direction of thrust reversibly movable from a forward propelling direction, to an upward propelling direction; or
ii) the direction of thrust fixed in an upward propelling direction;
wherein the PPM is capable of providing a thrust:
i) the direction of thrust reversibly movable from a forward propelling direction, to an upward propelling direction; or
ii) the direction of thrust fixed in an upward propelling direction;
wherein the CPM is capable of providing a thrust, the direction of thrust being in a forward propelling direction; and
wherein the TPM and PPM are connected to the wing, and wherein the TPM is located in fore of the wing and the PPM is located in aft of the wing.

21. The aircraft of claim 20, wherein the TPM, PPM and CPM are independently (i) battery powered; (ii) battery-hybrid powered or (iii) turbo-electrically powered.

22. The aircraft of claim 20, wherein each TPM and PPM comprises 6 to 24 propulsion units.
